(19) United States
(12) Patent Application Publication
(10) Pub. No.: US 2017/0014890 A1
(43) Pub. Date: Jan. 19, 2017

(54) TOOL SLIDE

(71) Applicant: VOESTALPINE GIESSEREI LINZ GMBH, Linz (AT)

(72) Inventor: Markus Meyer, Wangen im Allgäu (DE)

(21) Appl. No.: 15/124,004

(22) PCT Filed: Mar. 5, 2015
(86) PCT No.: PCT/EP2015/054663

§ 371 Date: Sep. 6, 2016

(30) Foreign Application Priority Data
Mar. 6, 2014 (DE) 10 2014 102 998.4

(51) Int. Cl. B21D 28/32; B30B 1/40

(52) U.S. Cl. CPC B21D 28/325; B30B 1/40

(57) ABSTRACT

A tool slide, in particular a wedge drive, including at least one slide bed and one slide body. The slide body is arranged on the slide bed in sliding fashion with a prism guide, and a groove and a stud protruding into the groove are provided. Between the stud and the groove, at least one sliding element is provided. A driver that can be removed from the slide body is provided and between the slide body and the driver in the contacting state, there is likewise a prism guide composed of inclined elements of the slide body and corresponding inclined surfaces of the driver. Between the slide bed and the slide body, a prism guide or flat guide is embodied so that the sliding elements of the slide bed and corresponding sliding elements of the slide body are inclined relative to an x axis in a prism guide or are perpendicular in a flat guide. The sliding element has a wedge-like, inclined surface oriented toward the groove with which it rests on a corresponding surface of the groove wall and the corresponding groove wall has a corresponding wedge-like inclined surface so that an axial movement of the sliding element in a longitudinal direction reduces or enlarges a gap between the stud and the sliding element.

### FIELD OF THE INVENTION

The invention relates to a tool slide.

### BACKGROUND OF THE INVENTION

Tool slides, which are also referred to as wedge drives, are known.

Wedge drives are used in tools in metalworking, e.g. in forming presses. These wedge drives are usually connected to devices or tools that make it possible to perform a punching procedure or some other deforming procedure. A conventional wedge drive has an upper guide part, which includes a slide element and a slide guide element, and a lower guide part, which includes a driver element, or vice versa. On the slide guide element side, the wedge drives are moved by means of a drive that exerts a generally vertical pressing force. On the driver element side, wedge drives in the tool or press are fastened to a base plate onto which the workpiece to be machined is placed directly or by means of a corresponding support device.

DE 26 40 318 B2 has disclosed a wedge drive for converting a vertical pressing force into a force acting obliquely thereto for the forming process. This wedge drive is composed of a driving wedge, on which a vertical force of a corresponding working press acts, and a slide wedge, which transmits the force in the horizontal direction. The driver wedge and the slide wedge travel over a rounded cooperating region or in another embodiment, over a roller.

DE 24 39 217 A1 has disclosed a wedge press with a prism-shaped wedge guide in which the contact surfaces are embodied as roof-shaped or trough-shaped and in which the roof or trough extends across the entire pressure-absorbing width of the wedge.

DE 23 29 324 B2 has disclosed a wedge press with a device for preventing unwanted movements of the wedge with a prism-shaped wedge guide.

Usually, suspended wedge chives, which are used in the vehicle body industry, are composed of a driver, a slide, and a slide recess. The top side of the slide recess is acted on with a perpendicular force, which pushes the slide recess downward. The driver is firmly anchored in the tool so that when pressure is exerted on the slide recess, the slide that is anchored in the slide recess is pushed in any desired direction other than the perpendicular working direction.

Suspended wedge drives are used frequently. In this design, the slide is suspended in its guide so that it is able to move in the slide recess. The driver is supported rigidly in the lower part and predefines the working direction of the slide. With the downward stroke of the press, the decompressed slide comes to rest on the driver and is slid across the driver surface in the working direction by the continuing motion of the slide recess.

The wedge drives known from this prior art have disadvantages so that the slides used frequently have only a short service life and because of their structural design, are subject to intense wear. They must therefore be frequently replaced even after short service lives because they are experiencing wear phenomena so that a precise conversion of vertical pressing forces is no longer possible, which results in unacceptable tolerances in metalworking.

DE 197 53 549 C2 has disclosed a wedge drive, which can be produced in a continuous industrial production process and is supposed to have a long service life. To guide the slide in the slide recess, inclined strips are provided, which are made of bronze and are equipped with sliding elements made of graphite that are mounted in the inclined strips. Generally, this wedge drive for converting as vertical pressing force is equipped with a driver, a slide, and a slide recess; the driver has a prism guide and the path of travel of the slide on the driver is shorter than the path of travel of the slide on the slide recess, where the ratio of the paths of travel to each other is at least 1 to 1.5 and the angle α between the paths of travel is 50 to 70. In a slide of this kind, the driver element has a prismatic surface, with the flanks of the prismatic surface being embodied as sloping down toward the outside. In addition, this wedge drive has forced retrieval brackets on two opposing sides, each in a respective groove of the slide element and driver element. If a spring element that returns the slide element to its starting position breaks, then these brackets ensure a retrieval of the slide element when spring breakage occurs, thus preventing the screwed-on stamp elements from tearing off. The slide element is fastened to the slide guide element by means of the inclined strips and retaining screws and can be moved along the inclined strips relative to the slide guide element.

U.S. Pat. No. 5,101,705 A has disclosed another wedge drive in which the slide element is suspended on inclined strips or is fastened by means of them to the slide guide element. In this case, the plates resting against one another and the elements required for the fastening must be ground precisely in order to ensure the necessary clearance between the slide element and the slide guide element. In this wedge drive and also in the other known wedge drives in which the slide guide element and slide element are connected to each other by means of inclined strips and screws, it is disadvantageous that all of the tensile forces are introduced into the screws, as a result of which particularly at the moment in which an expansion of the screws and of the material surrounding them occurs, there is a negative impact on the clearance of the slide guide elements and slide elements that are moving relative to each other. This subsequently results in a reduced service life since the wear in this region is particularly increased due to the distortion of the tool in this region. It also turns out to be disadvantageous that the slide element cannot expand laterally when it is heated because it is restricted in this regard by the inclined strips. This can likewise result in increased wear on the tool.

EP 1 197 319 A1 has disclosed a wedge drive in which the slide element and the slide guide element are held together by means of guide brackets. As a result, it should not be necessary for additional inclined strips or other elements that connect these two elements to be precisely ground in order to ensure a required clearance. In addition, there is no negative impact on the clearance even when the wedge drive and the tool are heated because not only production tolerances, but also accompanying expansions of the material can be absorbed by the connection by means of a guide bracket. The service life of the wedge drive is thus likewise no longer negatively affected or shortened. Despite the elimination of a grinding, it is possible to achieve a high degree of running accuracy. The guide brackets in this case engage in a form-fitting manner in the slide guide element so that the guide brackets suspend the slide element on the slide guide element by means of this form-fitting engagement. As a result of this, it is not necessary to provide a fastening to the slide guide element by means of screws, which are on the one hand susceptible to wear and on the other hand, can cause the above-mentioned negative impact on the clearance when they are heated.

DE 10 2007 045 703 A1 has disclosed a wedge drive with a slide recess in which a dovetail-like or prismatic guide device is provided between the slide element and the slide element recess. This document explains that with an approximately perpendicular approaching motion of a press tool, which is referred to as the working stroke, the slide element, which is in its rear position, comes to rest on the rigid protruding driver element and, supported by the latter, is driven by means of its inclined position oriented in the working direction. The movable slide element is thus driven only by the press tool and is steered forward or toward the outside, in order to be able to execute the stamping- or forming work. In the rearward stroke in which the press tool has moved beyond its lower suction point and its two parts are moving apart from each other again, usually the movable slide element is slid back into its starting position by means of a correspondingly designed spring-elastic element, after which the process can be started again. It is stated that the withdrawal force required for retrieval of the slide element is usually between 2% and 10% of the actual working force and weight of the slide element. In this case, the decisive factors for the magnitude of the pressing force should be the dimensions of the surfaces transmitting the pressure, which are referred to as slide surfaces, the respective inclinations of linear guides in the slide element recess, the inclination of the driver element, the interplay of the areas and inclinations, and the design of the slide element itself. The pressures to be transmitted are usually between <100 kN and up to several tens of thousands of kN.

It is also stated that the linear guidance in the slide element recess should guide the movable slide element without play and in so doing, must withstand powerful pressing forces and achieve a long service life. A tolerance of 0.02 mm is set as a tolerance of the running accuracy of the movable slide element.

As has also been explained in the prior art, such wedge drives or slides are composed of a slide assembly, which is in turn composed of a driver, a slide part, and a slide bed. In this connection, the slide part is fastened to the slide bed with retaining elements, with the slide part being suspended in sliding fashion between the driver and the slide bed. Corresponding inclined surfaces on the slide bed and driver are inclined in opposite directions so that the slide part is “pushed out” between the two parts when the slide bed and driver are brought together. Since, as explained above, very powerful forces occur in this case, a corresponding guide must be provided.

The known types of guidance in this case are cover strip guidance, guide bracket guidance, guide column guidance, and dovetail guidance (DE 10 2007 043 703 A1).

The overwhelming majority of these guides are mounted to the outer surface of the slide. In this case, it should be noted that the transmission of force and the guidance are not optimal. On the one hand, the main slide guidance by means of the slide surfaces must therefore be offset toward the inside, meaning that less transmission of force is possible. In addition, this frequently requires more space and deformations can be observed due to the introduction of operating forces (working- and withdrawal forces).

With the known dovetail guidance, it is disadvantageous that the play must be frequently remachined, which requires the slide to be completely dismantled. Furthermore, in all other sliders, installation and removal are very complex and labor-intensive. On the one hand, this can only be carried out toward the rear in the whole slide body; particularly in large sliders due to the high weight of the slide body and the extremely limited installation spaces, large masses must be moved in narrow guidance with the aid of a crane. With bracket slides, space to the side must be provided for the installation and removal so that for certain applications, there is no reliable guarantee that an optimized position of the slide will be achieved.

DE 10 2012 014 546 A1 has disclosed a wedge drive; the wedge drive should have a slide element recess, a movable slide carriage, and a driver and is embodied with slide surfaces between the slide carriage and the driver element; in at least one slide surface, a tensioning device should be provided, which adjustably simulates the pressing force during the installation of the working tool in order to achieve a play-free state between the at least one slide carriage and the at least one slide recess. According to this document, a high tolerance precision should be achieved, namely when the upper part of the slide, which includes the slide carriage and the slide element recess on the one hand and the driver on the other, is mounted in the tool; this is supposed to be achieved by the fact that when the working tool is mounted on the slide, i.e. when a working tool such as a hole punch is fastened to the slide, the slides are held together with the simulated pressing force.

The object of the invention is to create a slide guide that has optimized properties with regard to overall size and force transmission while improving the installation efficiency.

### SUMMARY OF THE INVENTION

According to the invention, the slide guide between the slide body and the slide bed is embodied as a prism guide or flat guide; in addition, a guide stud with a prismatic or dovetail-shaped cross-section is supported in a groove with a corresponding cross-section and with slide elements that are part of the respective other corresponding upper part of the slide supporting the stud. In addition to the prism-shaped or dovetail-shaped embodiment, according to the invention, the guide play can be adjusted by means of the interplay between at least two inclined surfaces between a sliding element and the slide bed supporting it. In addition, a separate sliding element can be provided for this.

In detail, this guide is used in as known slide assembly, which is composed of the driver, the slide part, and the slide bed, with the slide part being supported in sliding fashion in the slide bed. Sliding pairs are positioned between the driver and the slide part.

In an advantageous modification, the adjustment of the guide play is at least secured—possibly also performed—by means of a separate component. This component is permitted to mechanically act in an adjustment direction on the sliding element and/or sliding elements that have the inclined surface or surfaces. In this case, the component can on the one hand produce a spacing specified for the performed adjustment, between a stationary part of the slide body and/or slide bed on the one hand and the adjustable slide surface on the other.

Also according to the invention, the component itself can be embodied as wedge-like or wedge-shaped, with an inclined surface, which cooperates with a corresponding inclined surface of the slide surface that is to be adjusted, in a way that causes the slide surface to move. In this case, the component is provided with an actuating means that is able to move the component from the outside in a simple way, causing the slide surface to move. In particular, this actuating means is embodied in the form of an adjusting screw that is able to net on the component in relation to the slide surface, causing the component to move.

With an in particular prism-shaped or dovetail-shaped embodiment, the slide bed, for example, has the dovetail-shaped recess for accommodating the dovetail-shaped tongue, with a sliding element being embodied on the outside of the dovetail-shaped tongue and at least one slide surface on the slide bed.

The sliding element is embodied as wedge-like with an inclined surface. This inclined surface in this case is embodied on the groove-side short surface of an L-shaped sliding element; then the groove is provided with a corresponding wedge-like surface, in particular a corresponding inclined surface.

In this case, both of the sliding elements or only one sliding element can have the inclined surface. By sliding the sliding element along the direction of the inclined surface (usually in the longitudinal direction of the elongated slide strips), the guide play between the slide bed and the slide body is changed.

The L-shaped sliding element in this case can also be composed of individual sliding elements, which are arranged in an L shape relative to each other, but this increases the amount of installation effort.

Particularly in the case in which both of the sliding elements have the inclined surface, an adjustment of the slide bed relative to the slide body can also be achieved by sliding the slide strips or sliding elements in opposite directions.

The invention relates to a tool slide, in particular a wedge drive, which has at least one slide bed and one slide part; the slide part is supported on the slide bed in sliding fashion with a prism guide, and a groove and a stud protruding into the groove are provided; between the stud and the groove, at least one sliding element is provided; a driver is provided that can be removed from the slide part and between the slide part and the driver in the contacting state, there is likewise a prism guide composed of inclined elements of the slide body and corresponding inclined surfaces of the driver; and between the slide bed and the slide body, a prism guide or flat guide is embodied so that the sliding elements of the slide bed and corresponding sliding elements of the slide body are inclined relative to an x axis in a prism guide or are perpendicular to it in a flat guide; oriented toward the groove, the sliding element has a wedge-like, inclined surface with which it rests on a corresponding surface of the groove wall and the corresponding groove wall has a corresponding wedge-like inclined surface so that an axial movement of the sliding element in a longitudinal direction reduces or enlarges a gap between the stud and the sliding element.

The invention also relates to a tool slide in which the sliding elements are L-shaped slide strips or slide plates, which have surfaces oriented toward the groove center with which they delimit an intermediate space between themselves and, oriented toward the slide body, have slide surfaces; the guide part or the guide stud extends upward into the groove symmetrically to the vertical axis; and the guide stud has elongated surfaces with which it rests against the surfaces 11 of the L-shaped slide strips.

The invention also relates to a tool slide in which the guide body is embodied as an elongated rail-like or stud-like component; the stud is embodied so that it widens out in prismatic or dovetail-shaped fashion into the region that protrudes into the groove; a guide prism or a dovetail guide is provided, which is supported in the groove; and the stud is supported in the groove with prismatic surfaces against corresponding surfaces of slide strips.

The invention also relates to a tool slide in which an adapter is provided, which is inserted between a wall of the slide bed and a wall of the sliding element and maintains a definite position of the sliding element.

The invention also relates to a tool slide in which the adapter positioned with a screw on the slide bed or sliding element.

The invention also relates to a tool slide in which the adapter has at least one wedge-like, inclined surface, which corresponds to an inclined surface of the slide bed or an inclined surface of the sliding element functioning as a wedge drive for moving the sliding element.

The invention also relates to a tool slide in which the adapter has wedge-like inclined surfaces, which correspond to both an inclined surface of the slide bed and an inclined surface of the sliding element functioning as a wedge drive for moving the sliding element.

The invention also relates to a tool slide in which in order to adjust the guide play, the adapter is positioned between an edge or surface of the slide bed situated axially in front of or behind the slide strip. This edge or surface is spaced apart from an end surface of the slide strip.

The invention also relates to a tool slide in which the adapter, in order to be secured in its position, has a fixing element that overhangs the edge or surface oriented toward the slide bed, particularly in the vicinity of a step provided for it, and is fixed in position there by means of a screw, which reaches through the adapter and is then screwed into the material of the slide bed, thus fixing the axial distance between the edge and the edge.

In one embodiment of the invention, the adapter is positioned between the edges; the adapter between the edges is arranged in movable fashion and the overhanging region and the step are spaced apart so that the adapter is positioned in such a way that it can be pushed into the region between the edges by screwing in the screw the edge or surface of the adapter oriented toward the slide strips is provided with an inclined surface so that the adapter is embodied as widening and/or the edge of the slide strip is provided with a corresponding inclined surface in such a way that when the adapter is pushed inward into the region between the edges, this causes the slide strip to move, as a result of which the guide play is reduced.

In another embodiment of the invention, for the purpose of moving the wedge-shaped adapter or wedge into and out of the wedge-shaped gap between the surfaces of the slide bed and the slide strip, the wedge has an elbow, which is positioned on the wedge in such a way that the free end of the elbow is situated in the vicinity of the material of the slide bed or slide strip and has a screw extending through it, which is supported in the elbow in rotary fashion; by means of its screw head and/or by means of a corresponding device, the screw acts on the wedge in such a way that screwing the screw into the slide bed or slide strip moves the wedge into or out of the gap.

### BRIEF DESCRIPTION OF THE DRAWINGS

The invention will be explained below by way of example based on the drawings. In the drawings:

FIG. 1: a cut-away view of a tool slide according to the invention;

FIG. 2: is a partially cut-away view of another embodiment of the slide according to FIG. 1;

FIG. 3: shows the slide bed of the slide according to the invention with the adjustments of the slide strips;

FIG. 4: is a rear view of the adjustment state according to FIG. 3;

FIG. 5: shows the slide bed according to FIG. 3 in another adjustment view of the strips;

FIG. 6: is a rear view of the adjustment state according to FIG. 5;

FIG. 7: shows another embodiment of the tool slide according to the invention, with another embodiment of the adjustment of the slide strips;

FIG. 8: shows the slide bed in a view according to FIG. 7 from the rear, showing the adjusting mechanism in the closed state;

FIG. 9: shows another partially cut-away view of the tool slide according to FIG. 7;

FIG. 10: shows a view according to FIG. 9 of the back side of the tool slide in an open state;

FIG. 11: shows the tool slide according to the invention with an adapter for fixing the slide strip in position;

FIG. 12: shows the tool slide according to FIG. 11 in a detail view in accordance with the cutting line A-A;

FIG. 13: shows another embodiment of the adapter in a tool slide according to FIG. 11 with an inclined surface for adjusting;

FIG. 14: shows a tool slide in the lifted state, with the driver at the bottom and the prism guide in the unfixed state, with gap dimensions;

FIG. 15: shows the tool slide according to FIG. 11 in the brought-together state; the production-induced offset is adjusted by means of the gap dimensions and the centering on the driver;

FIG. 16: shows the tool slide according to FIG. 11 in the brought-together state with fixed gap dimensions after the adjustment of the guide play by means of the adjustable strips;

FIG. 17: shows a slide with cover strip guidance according to the prior art;

FIG. 18: shows a slide with column guidance according to the prior art;

FIG. 19: shows a slide with bracket guidance according to the prior art;

FIG. 20: shows a slide with dovetail guidance according to the prior art.

### DETAILED DESCRIPTION OF THE PREFERRED EMBODIMENTS

A tool slide 1 according to the invention has a slide bed 2, a slide body 3, and a driver 4.

In the case shown, the slide part 3 is arranged so that it is suspended on the slide bed 2; the slide part 3 can be lifted up from the driver 4. The driver 4 is usually positioned on a first tool half (the lower one in the case shown), while the slide part 3 is positioned above the slide bed 2 on a corresponding second (upper) tool half (not shown).

The slide bed 2 is embodied as approximately box-shaped and has an elongated rectangular groove 5; next to the elongated rectangular groove 5, screw holes 6 are provided to accommodate corresponding screws (not shown). The groove 5 and the adjacent surfaces 7 delimiting the groove form a bearing surface for L-shaped slide strips 8, which rest on the surfaces 7 and extend into the groove 5 with one L-leg 9.

The L-shaped slide strips 8 have mounting holes 10 for screwing in mounting screws for insertion into screw holes 6. The L-shaped slide strips 8 have diverging surfaces 11 oriented toward the groove center with which they delimit a prismatic intermediate space between themselves.

Facing the walls 19 that laterally define the groove 5 and resting against them, the L-legs 9 have slide surfaces 22. The surfaces 22, relative to the thickness of the L-legs 9 between the groove side wall 19, extend along the longitudinal span of the L-shaped slide strips 8 in an inclined fashion so that the L-legs 9 are embodied as wedge-like or wedge-shaped. This inclined surface or wedge shape in this case extends at an angle of 1°to 5°. In a corresponding way, the groove side walls 19 are provided with a surface that is inclined relative to the longitudinal span so that a movement of the slide strips 8 in accordance with the longitudinal direction moves the surfaces 11 closer to or farther from the groove center.

Toward the slide body 3, the L-shaped slide strips 8 have slide surfaces 12, which are embodied as flat and are oriented perpendicular to a depicted x axis 13.

Toward the surfaces 12, the slide body 3 has corresponding slide surfaces or slide strips 14, which are embodied as sliding partners for the L-shaped slide strips 8.

Symmetrical to the vertical axis, a guide part 15, which is in particular embodied as a guide prism or dovetail, extends upward between the slide strips 14 and into the groove 5. In this case, the guide prism 15 has elongated prismatic surfaces 16 with which it rests against the surfaces 11 of the L-shaped slide strips 8.

Oriented toward the driver, the slide body 3 has other slide strips 17, which are inclined relative to the x axis 13 and correspond to prismatic guide surfaces 18 of the driver 4. The strips 17, because they are connected to the slide body, constitute liftable slide strips, which are brought into an operative connection with the surfaces 18 when the upper part and bottom part of the tool are brought together.

Since the guide surfaces of the L-shaped slide strips 8 and the corresponding surfaces 12 of the strips 14 are perpendicular to the x axis 13 and are also perpendicular to the guide prism 15, this embodiment is referred to as a so-called flat guide.

The inclined corresponding sliding elements 17, 18 between the slide body and driver form a so-called prism guide.

In another advantageous embodiment (FIG. 2, the same parts are provided with the same reference numerals), the tool slide 1 is likewise composed of a slide bed 2 and a slide body 3 (the driver 4 is not shown).

In the case shown, the slide part 3 is positioned on the slide bed 2 in suspended fashion; the slide part 3 can be lifted up from the driver 4. The slide bed 2 is approximately box-shaped and has an elongated groove 5. The groove side walls 19, which extend from the groove bottom, extend in converging fashion and consequently form a dovetail groove. The surfaces 7 delimiting the groove 5 converge toward each other. The surfaces 7 have L-shaped slide strips 8 resting on them, which extend into the groove with a narrow, short L-leg 9. The L-shaped slide strips have contact surfaces 11 oriented toward the surfaces 7 and have slide surfaces 12 oriented toward the slide body 3, which are flat and are embodied as diverging in an inclined fashion relative to a vertical axis. These surfaces 12 slide on corresponding slide surfaces 14 of the slide body 3.

The slide surfaces 14 of the slide body 3 are consequently embodied as inclined in roof-shaped fashion; the guide stud 15 or dovetail-shaped part of the guide stud 15 of the slide body is positioned so that in the middle, it is centrally situated in symmetrical fashion relative to the vertical axis; and the prismatic surfaces 16 are embodied as resting against the short L-shaped legs 9 of the slide strips 8. The surfaces 16 and 14 in this case enclose approximately the same angle as the surfaces 9, 12 and in the example shown, are approximately perpendicular to each other.

Since it is necessary to achieve an exact fit and guidance of the tool slide, particularly between the slide bed and the slide body, the guidance of the slide body in the slide bed must be adjustable or more precisely, the slide strips 8 and prism 15 must be adjusted relative to one another.

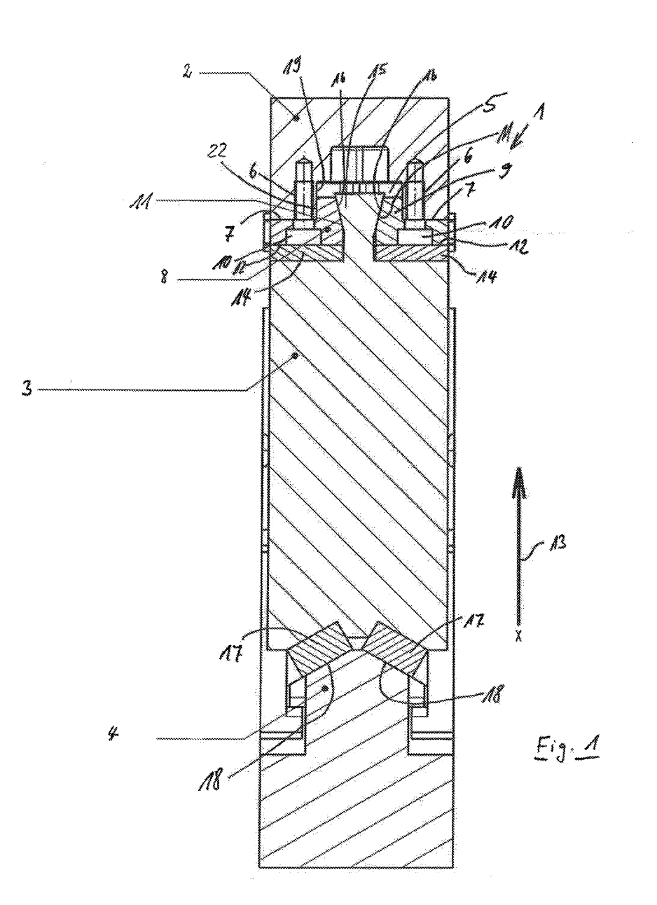

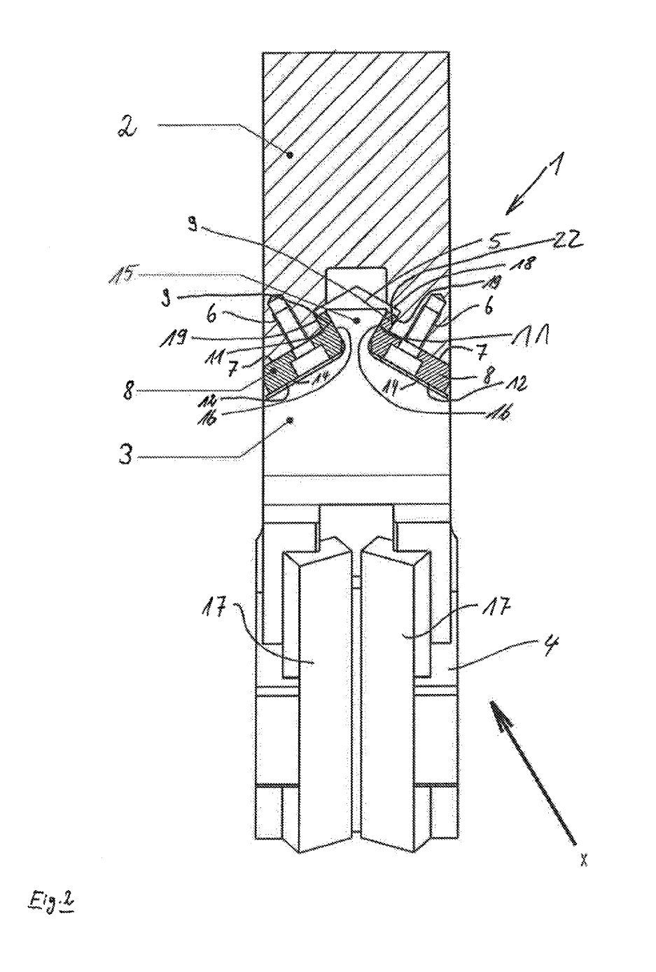

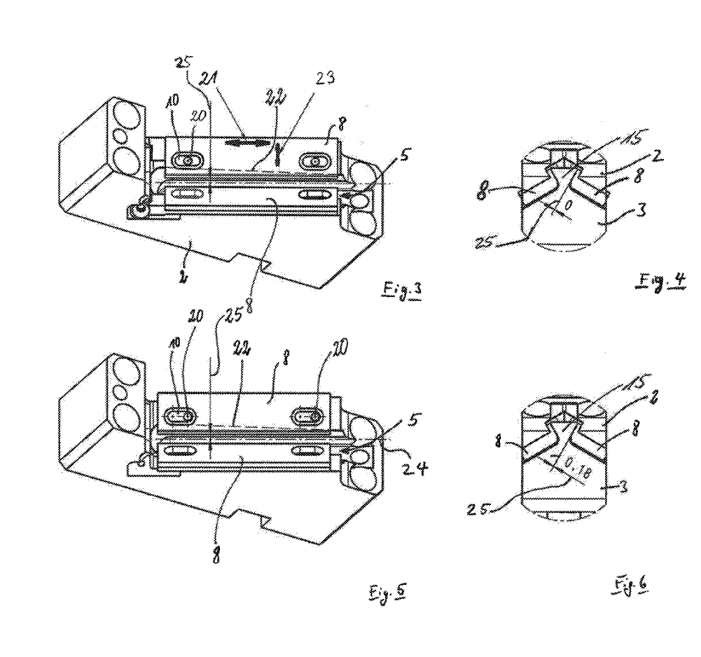

To this end, (FIGS. 3 through 6) the mounting holes 10 in the slide strips 8 are embodied as oblong holes so that the strips can be moved along the mounting screws 20 and thus along an adjustment direction 21.

The movement of the slide strips 8 along the direction 21 does not change anything yet with regard to possibly existing gaps or spaces between the surfaces of the slide strips 8 or L-legs 9 and of the guide prism 15. With regard to the longitudinal span or the directions 21, therefore, the contact surfaces 22 of the L-legs 9 of the L-shaped slide strips are wedge-like or wedge-shaped analogous to the first embodiment 8. This means that they change in thickness over their longitudinal span. The inclined surface has a slope of 1-5 degrees, for example.

The inclined contact surfaces 22 on the L-legs 9 of the L-shaped slide strips 8 are oriented toward corresponding surfaces 19 of the groove 5.

Because of the inclined surfaces 22, 19, a sliding along the direction 21 therefore causes the distance between the surfaces 11 of the L-legs 9 and the surfaces 16 of the guide stud 15 or guide prism 15 to be reduced or eliminated. In this case, it is possible for both of the slide strips 8 to be moved or for only one slide strip 8 to be moved.

Since this simultaneously causes the slide strips to come closer to each other or move farther away in the transverse direction, i.e. the direction 23, in this case, however, the oblong holes 10 had to be embodied so that they also enable a floating support in the direction 23 around the screws 20.

In order to adapt the slide strips 8 to the guide prism 15 and thus also to adapt the exact position of the slide body in the slide bed, it is possible, for example, to perform the adjustment from as stop position of the screws 20 in the oblong holes 10 (FIG. 5).

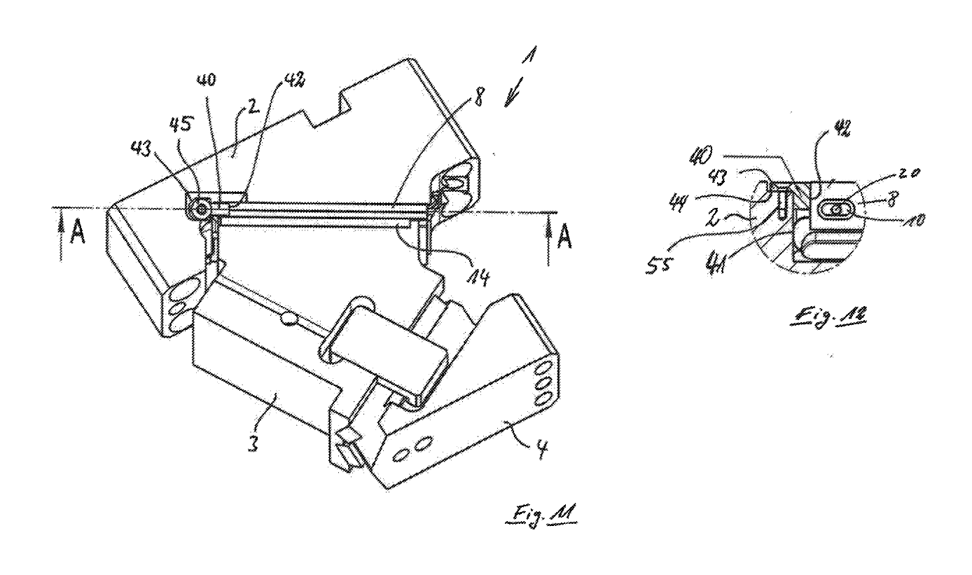

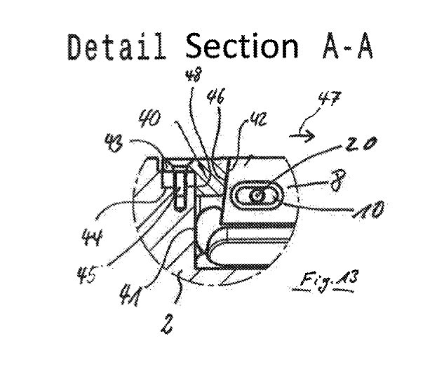

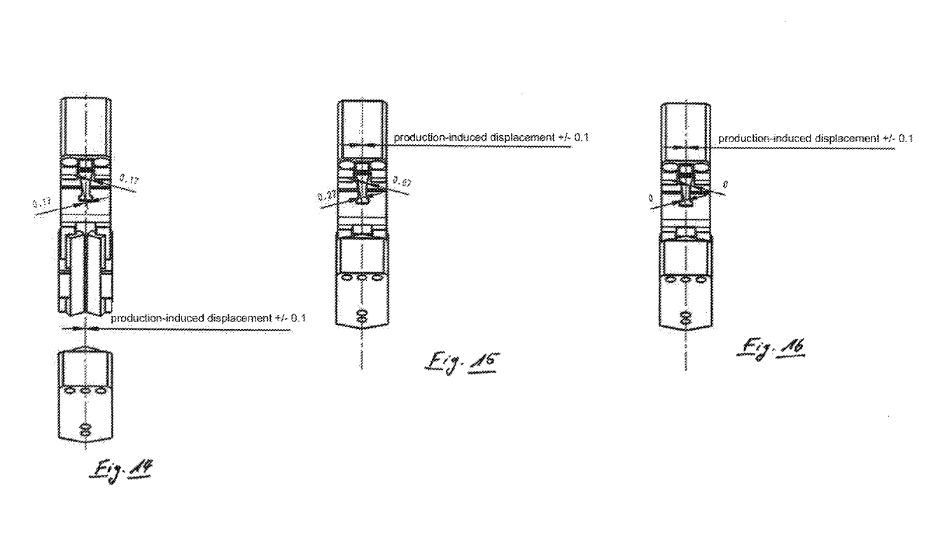

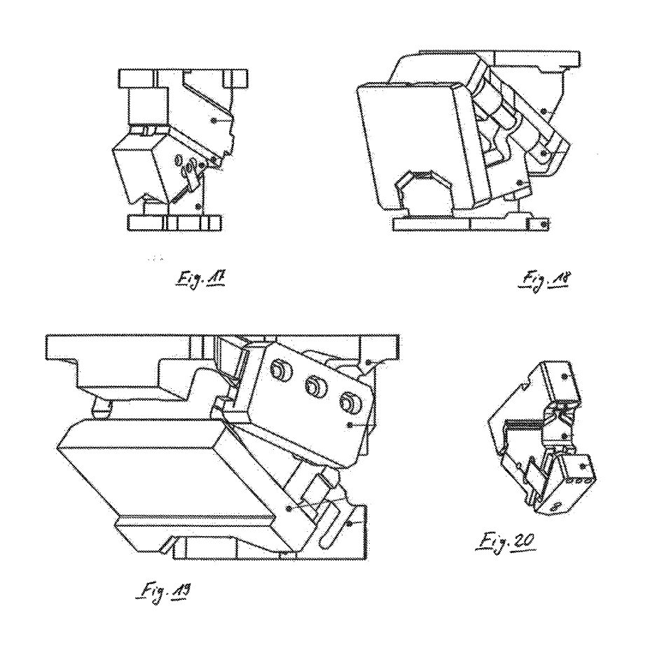

According to the invention, an adapter 40 is provided so that a corresponding adjustment of the guide play can be fixed in position from the outside (FIGS. 10, 11). The adapter 40 is positioned between an edge or surface 41 of the slide bed 2 situated axially in front of or behind the slide strip 8 and this edge or surface 41 is spaced apart from an end surface 42 of the slide strip 8. In order to secure the adapter 40 in its position, the adapter has a fixing element 43 that overhangs the edge or surface 41 oriented toward the slide bed 2, particularly in the vicinity of a step 44 provided for it, and is fixed in position there by means of a screw 45, which reaches through the adapter 40 and is then screwed into the material of the slide bed 2. The axial distance between the edge 41 and the edge 42 can thus be fixed so that the position of the screws 20 in the oblong holes 10 remains fixed. In order to fix different distances between the screws 20 and the oblong holes 10 depending on the adjustment position, the adapters can have different widths between the edges 41, 42.

This means that after the adjustment and fixing of the slide strip 8 by means of the screws 20, which are resting in the oblong holes 10, an appropriate adapter 40 is inserted in order to secure this adjustment.

In another advantageous embodiment of the invention (FIG. 12) the adapter is likewise situated between the edges 41, 42, but is arranged so that it is able to move between the edges 41, 42 to the extent that the overhanging region 43 and the shoulder 44 are spaced apart from each other in such a way that by screwing in the screw 55, the adapter 40, viewed from the outside, can be pushed deeper into the region between the edges 41, 42. In addition, the edge or surface 46 of the adapter 40 oriented toward the slide strips is provided with an inclined surface so that the adapter 40 is embodied as widening toward the outside. The edge 42 of the slide strip 8 is provided with a corresponding inclined surface in such a way that when the adapter 40 is pushed inward into the region between the edges 41, 42, this causes the slide strip 8 to move in the direction of the arrow 47. Preferably, the direction 47 is also the direction in which the guide play is reduced. By means of this, by screwing the screw 45 into the slide bed 2, the adapter 40 is screwed into the region between the edges 41, 42 and thus the slide strip 8 is correspondingly pushed in a direction toward less play. In this case, it is advantageous that the screwing in of the adapter from the outside, which is relatively easy to perform, permits the guide play to be easily moved or adjusted.

Naturally, it is also possible to embody an edge 48 of the adapter 40 oriented toward the slide bed with the corresponding inclined surface and thus to embody the edge 41 on the slide bed with a corresponding inclined surface, which functions in the same way as in the first embodiment.

Particularly with an inclined installation of the slide strips 8, the screws 45 are recessed from the outside and set back from the outer surface of the slide bed 2 to prevent damage and can nevertheless be easily reached, particularly with an offset screwdriver or tools of the like.

In another advantageous embodiment (FIG. 7 through 10), the adjustment takes place in a different way. In this embodiment, the surfaces 19 of the groove 5 and/or the slide bed 2 and/or the surface 22 that is oriented toward the wall 19 are embodied with an inclined surface. If both surfaces 19, 22 are embodied as inclined, then the inclined surfaces are embodied so that they are oriented in the same direction, i.e. the surfaces diverge or converge relative to each other and delimit a wedge-shaped intermediate space between themselves.

In order to adjust the distance between the slide surface 11 and a prism 15, which has slide surfaces 16 and is situated between the slide surfaces 11, in this embodiment, a corresponding wedge-shaped adapter is used, which depending on the design, either has an inclined surface 64 oriented toward the wall 22 or an inclined surface 65 oriented toward the wall 19 or has two inclined surfaces 64, 65 oriented toward the inclined walls 19, 22, This wedge consequently rests against these walls 19, 22 and extends between the slide strip 8 and the groove 5.

If this wedge 60 is moved into or out of the gap between the surfaces 19, 22 in accordance with a movement direction 61, then the slide strip 8 is consequently moved as a unit either in the direction toward a groove center 62 or away from it, respectively, in accordance with the directions 23.

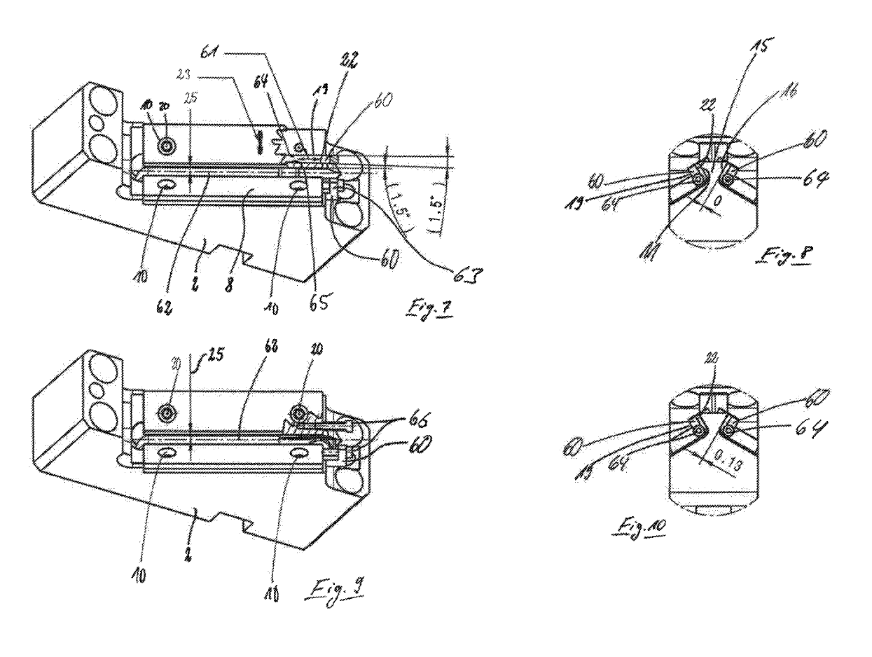

In order to be able to move the wedge-shaped adapter or the wedge 60 into or out of the gap, the wedge 60 has an elbow 63, which is positioned on the wedge in such a way that the free end of the elbow is situated in the vicinity of the material of the slide and in this case in particular, that of the slide bed 2. The elbow region 63 has a screw 66 extending through it, which is supported in the elbow 63 in rotary fashion. By means of its screw head or by means of a corresponding device, this screw 66 acts on the elbow region 63 in such a way that screwing the screw 66 into the slide bed 2 (FIG. 8) moves the wedge into the gap between the surfaces 19, 22 and screwing it out moves the wedge 60 back out again.

In another embodiment, the screw 66 is not screwed into the slide, in particular into the slide bed 2, but rather directly into the slide plates 8, which produces the same result when it is screwed in and out.

In the invention, it is advantageous that the externally adjustable, movable slide strips achieve a simple, but very reliable and rugged adjusting possibility with good accessibility, even in very cramped installation situations; it is not necessary to remove the entire slide for the adjustment, but instead, it is sufficient to adjust the adapter using the corresponding screws provided for this purpose.

In the invention, it is advantageous that the adjustable slide strips and their L-shaped embodiment one the one hand and the prismatic guide prism 15 on the other achieve a very compact, but also very stable guidance of the slide body 3 in the slide bed 2 and in addition, extremely strict tolerances can be set in a simple way.

1. A tool slide, comprising:
at least one slide bed;
a slide body arranged on the slide bed in sliding fashion with a prism guide and a groove;
a stud protruding into the groove;
at least one sliding element between the stud and the groove;
a driver that can be removed from the slide body; and
between the slide body and the driver in a contacting state, there is likewise a prism guide composed of inclined elements of the slide body and corresponding inclined surfaces of the driver; and
between the slide bed and the slide body, a prism guide or flat guide is embodied so that the sliding elements of the slide bed and corresponding sliding elements of the slide body are inclined in a prism guide or are perpendicular in a flat guide, wherein the sliding element has a wedge-like, inclined surface oriented toward the groove with which it rests on a corresponding surface of the groove wall and the corresponding groove wall has a corresponding wedge-like inclined surface so that an axial movement of the sliding element in a longitudinal direction reduces or enlarges a gap between the stud and the sliding element.

2. The tool slide according to claim 1, wherein the sliding elements are L-shaped slide strips or slide plates, which have surfaces oriented toward the groove center with which the surfaces delimit an intermediate space between themselves and, oriented toward the slide body, have slide surfaces; the stud extends upward into the groove symmetrically to a vertical axis; and the stud has elongated surfaces with which the stud rests against the surfaces of the L shaped slide strips.

3. The tool slide according to claim 1, wherein the guide body is an elongated rail-like or stud-like component; the stud widens out in prismatic or dovetail-shaped fashion into a region that protrudes into the groove; a guide prism or a dovetail guide is provided, which is supported in the groove; and the stud is supported in the groove with prismatic surfaces against corresponding surfaces of slide strips.

4. The tool slide according to claim 1, further comprising an adapter inserted between a wall of the slide bed and a wall of the sliding element, wherein the adapter maintains a definite position of the sliding element.

5. The tool slide according to claim 4, wherein the adapter is positioned with a screw on the slide bed on the sliding element.

6. The tool slide according to claim 4, wherein the adapter has at least one wedge-like, inclined surface, which corresponds to an inclined surface of the slide bed or an inclined surface of the sliding element functioning as a edge drive for moving the sliding element.

7. The tool slide according to claim 4, wherein the adapter has wedge-like inclined surfaces, which correspond to an inclined surface of the slide bed and to an inclined surface of the sliding element functioning as a wedge drive for moving the sliding element.

8. The tool slide according to claim 4, wherein, in order to adjust a guide play, the adapter is positioned between an edge or surface of the slide bed situated axially in front of or behind the slide strip.

9. The tool slide according to claim 4, wherein the adapter, in order to be secured in its position, has a fixing element that overhangs the edge or surface oriented toward the slide bed in the vicinity of a step provided for the fixing element, and is fixed in position there by a screw, which reaches through the adapter and is then screwed into the material of the slide bed, thus fixing the axial distance between two edges.

10. The tool slide according to claim 9, wherein the adapter is positioned between the two edges; the adapter between the two edges is arranged in movable fashion and the overhanging region and the step are spaced apart so that the adapter is positioned in such a way that it can be pushed into the region between the two edges by screwing in the screw; an edge or surface of the adapter oriented toward the slide strips is provided with an inclined surface so that the adapter is embodied as widening and/or the edge of the slide strip is provided with a corresponding inclined surface in such a way that when the adapter is pushed inward into the region between the two edges, this causes the slide strip to move, as a result of which the guide play is reduced.

11. The tool slide according to claim 4, wherein, for the purpose of moving the wedge-shaped adapter or wedge into and out of the wedge-shaped gap between the surfaces of the slide bed and the slide strip, the wedge has an elbow, which is positioned on the wedge in such a way that a free end of the elbow is situated in a vicinity of the material of the slide bed or slide strip and has a screw extending through it, which is supported in the elbow in rotary fashion; by means of its screw head and/or by means of a corresponding device, the screw acts on the wedge in such a way that screwing the screw into the slide bed or slide strip moves the wedge into or out of the gap.
